(19) United States
(12) Patent Application Publication
(10) Pub. No.: US 2025/0295998 A1
(43) Pub. Date: Sep. 25, 2025

(54) VORTEX COMPOSITE ENTITIES

(71) Applicant: International Business Machines Corporation, Armonk, NY (US)

(72) Inventors: Aaron K. Baughman, Cary, NC (US); Eduardo Morales, Key Biscayne, FL (US); Rahul Agarwal, Jersey City, NJ (US); Chandankumar Johakhim Patel, Fairborn, OH (US)

(21) Appl. No.: 18/609,181

(22) Filed: Mar. 19, 2024

(51) Int. Cl. A63F 13/65; A63F 13/52; A63F 13/67; A63F 13/812; G06T 11/00; G06T 11/60

(52) U.S. Cl. CPC A63F 13/65; A63F 13/52; A63F 13/67; A63F 13/812; G06T 11/001; G06T 11/60; G06T 2200/24; G06T 2210/16

(57) ABSTRACT

A computer-implemented method for generating a composite entity is provided. The computer-implemented method includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes.

### BACKGROUND

The present invention generally relates to artificial intelligence in computing systems. More specifically, the present invention relates to systems and methods for using artificial intelligence to create vortex composite entities on a plurality of similar virtual or real entities.

A virtual world (also called a virtual space) is a computer-simulated environment that can be populated by many users who can create personal avatars and simultaneously and independently explore the virtual world, participate in its activities and communicate with others. The avatars can be textual, graphical representations or live video avatars with auditory and touch sensations.

In a virtual world, users access a computer-simulated world which presents perceptual stimuli to the user, who in turn can manipulate elements of the modeled world and thus experience a degree of presence. Such modeled worlds and their rules may draw from reality or fantasy worlds. Example rules are gravity, topography, locomotion, real-time actions and communication. Communication between users can range from text, graphical icons, visual gesture, sound, etc.

### SUMMARY

According to an aspect of the disclosure, a computer-implemented method for generating a composite entity is provided. The computer-implemented method includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the computer-implemented method allows for a composite entity to be generated, shared and consumed.

According to an aspect of the disclosure, a computer program product for generating a composite entity is provided. The computer program product includes one or more computer readable storage media having computer readable program code collectively stored on the one or more computer readable storage media. The computer readable program code is executed by a processor of a computer system to cause the computer system to perform a method. The method includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the computer-implemented method allows for a composite entity to be generated, shared and consumed.

According to an aspect of the disclosure, a computing system is provided and includes a processor, a memory coupled to the processor and one or more computer readable storage media coupled to the processor. The one or more computer readable storage media collectively contain instructions that are executed by the processor via the memory to implement a method for generating a composite entity. The method for generating the composite entity includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the method for generating the composite entity allows for a composite entity to be generated, shared and consumed.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment for executing a computer-implemented method for generating a composite entity in accordance with one or more embodiments;

FIG. 2 is a block diagram of components of a machine learning training and inference system according to one or more embodiments;

FIG. 3 is a flow diagram illustrating a computer-implemented method for generating a composite entity in accordance with one or more embodiments;

FIG. 4 is a flow diagram illustrating the computer-implemented method of FIG. 3 in accordance with one or more embodiments;

FIG. 5 is a graphical illustration of an analysis using a logarithmic spiral expression in accordance with one or more embodiments;

FIG. 6 is a set of logarithmic spiral expressions for an attribute of an entity in accordance with one or more embodiments;

FIG. 7 is a flow diagram illustrating an overall flow based on an execution of the computer-implemented method of FIG. 3 in accordance with one or more embodiments; and

FIG. 8 is an illustration of a programmed training tool that is programmed based on an execution of the computer-implemented method of FIG. 3 in accordance with one or more embodiments.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

According to an aspect of the disclosure, a computer-implemented method for generating a composite entity is provided. The computer-implemented method includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the computer-implemented method allows for a composite entity to be generated, shared and consumed.

In accordance with additional or alternative embodiments, the entity is a tennis player, the aesthetics include racquet colors and tennis clothes of the entity and the performance attributes comprise tennis skills of the entity. In this way, the computer-implemented method is particularly applicable to tennis.

In accordance with additional or alternative embodiments, the identifying of the prime aesthetics and the prime performance attributes includes determining whether any of the aesthetics and the performance attributes in the list are independent from causal testing. This narrows the focus of the analysis.

In accordance with additional or alternative embodiments, the defining of the logarithmic spiral expressions for each of the prime aesthetics and for each of the prime performance attributes includes observing each of the prime aesthetics and each of the prime performance attributes over time and using feed forward networks (FFNs) to execute logarithmic spiral fits toward learning Θ, α and β components of each of the logarithmic spiral expressions for each of the prime aesthetics and each of the prime performance attributes. The use of logarithmic spiral expressions allows the computer-implemented method to obtain a degree of granularity that is not otherwise possible.

In accordance with additional or alternative embodiments, the computer-implemented method further includes automatically ranking the logarithmic spiral expressions for each of the prime aesthetics and for each of the prime performance attributes. This helps with the selection of the prime aesthetics and the prime performance attributes by the user.

In accordance with additional or alternative embodiments, the mixing of the logarithmic spiral expressions of the selections of the prime aesthetics and the prime performance attributes includes forecasted spiral mixing, simulated spiral mixing and actual spiral mixing. This increases the accuracy of the resulting composite entity.

In accordance with additional or alternative embodiments, the entity is a tennis player and the composite entity is a virtual tennis player and the computer-implemented method further includes executing multiple simulated competitions between the virtual tennis player and other virtual tennis players, comparing performances over time of the virtual tennis player in the simulated competitions with performances over time of the tennis player in actual competitions, refining the composite entity based on results of the comparing to generate a refined composite entity and automatically training the tennis player to improve based on exhibited weaknesses of the refined composite entity by automatically programming operations of training tools for use by the tennis player. This provides for tangible effects and benefits of the computer-implemented method.

According to an aspect of the disclosure, a computer program product for generating a composite entity is provided. The computer program product includes one or more computer readable storage media having computer readable program code collectively stored on the one or more computer readable storage media. The computer readable program code is executed by a processor of a computer system to cause the computer system to perform a method. The method includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the computer-implemented method allows for a composite entity to be generated, shared and consumed.

In accordance with additional or alternative embodiments, the entity is a tennis player, the aesthetics comprise racquet colors and tennis clothes of the entity and the performance attributes comprise tennis skills of the entity. In this way, the method is particularly applicable to tennis.

In accordance with additional or alternative embodiments, the identifying of the prime aesthetics and the prime performance attributes includes determining whether any of the aesthetics and the performance attributes in the list are independent from causal testing. This narrows the focus of the analysis.

In accordance with additional or alternative embodiments, the defining of the logarithmic spiral expressions for each of the prime aesthetics and for each of the prime performance attributes includes observing each of the prime aesthetics and each of the prime performance attributes over time and using feed forward networks (FFNs) to execute logarithmic spiral fits toward learning Θ, α and β components of each of the logarithmic spiral expressions for each of the prime aesthetics and each of the prime performance attributes. The use of logarithmic spiral expressions allows the method to obtain a degree of granularity that is not otherwise possible.

In accordance with additional or alternative embodiments, the method further includes automatically ranking the logarithmic spiral expressions for each of the prime aesthetics and for each of the prime performance attributes. This helps with the selection of the prime aesthetics and the prime performance attributes by the user.

In accordance with additional or alternative embodiments, the mixing of the logarithmic spiral expressions of the selections of the prime aesthetics and the prime performance attributes includes forecasted spiral mixing, simulated spiral mixing and actual spiral mixing. This increases the accuracy of the resulting composite entity.

In accordance with additional or alternative embodiments, the entity is a tennis player and the composite entity is a virtual tennis player and the method further includes executing multiple simulated competitions between the virtual tennis player and other virtual tennis players, comparing performances over time of the virtual tennis player in the simulated competitions with performances over time of the tennis player in actual competitions, refining the composite entity based on results of the comparing to generate a refined composite entity and automatically training the tennis player to improve based on exhibited weaknesses of the refined composite entity by automatically programming operations of training tools for use by the tennis player. This provides for tangible effects and benefits of the computer-implemented method.

According to an aspect of the disclosure, a computing system is provided and includes a processor, a memory coupled to the processor and one or more computer readable storage media coupled to the processor. The one or more computer readable storage media collectively contain instructions that are executed by the processor via the memory to implement a method for generating a composite entity. The method for generating the composite entity includes deriving a list of aesthetics and performance attributes for an entity, generating a directed acyclic graph (DAG) from the aesthetics and the performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes. In additional or alternative embodiments, the method for generating the composite entity allows for a composite entity to be generated, shared and consumed.

In accordance with additional or alternative embodiments, the entity is a tennis player, the aesthetics comprise racquet colors and tennis clothes of the entity and the performance attributes comprise tennis skills of the entity. In this way, the method for generating the composite entity is particularly applicable to tennis.

In accordance with additional or alternative embodiments, the identifying of the prime aesthetics and the prime performance attributes includes determining whether any of the aesthetics and the performance attributes in the list are independent from causal testing. This narrows the focus of the analysis.

In accordance with additional or alternative embodiments, the defining of the logarithmic spiral expressions for each of the prime aesthetics and for each of the prime performance attributes includes observing each of the prime aesthetics and each of the prime performance attributes over time and using feed forward networks (FFNs) to execute logarithmic spiral fits toward learning Θ, α and β components of each of the logarithmic spiral expressions for each of the prime aesthetics and each of the prime performance attributes. The use of logarithmic spiral expressions allows the method for generating the composite entity to obtain a degree of granularity that is not otherwise possible.

In accordance with additional or alternative embodiments, the method for generating the composite entity further includes automatically ranking the logarithmic spiral expressions for each of the prime aesthetics and for each of the prime performance attributes. This helps with the selection of the prime aesthetics and the prime performance attributes by the user.

In accordance with additional or alternative embodiments, the mixing of the logarithmic spiral expressions of the selections of the prime aesthetics and the prime performance attributes includes forecasted spiral mixing, simulated spiral mixing and actual spiral mixing. This increases the accuracy of the resulting composite entity.

In accordance with additional or alternative embodiments, the entity is a tennis player and the composite entity is a virtual tennis player and the method further includes executing multiple simulated competitions between the virtual tennis player and other virtual tennis players, comparing performances over time of the virtual tennis player in the simulated competitions with performances over time of the tennis player in actual competitions, refining the composite entity based on results of the comparing to generate a refined composite entity and automatically training the tennis player to improve based on exhibited weaknesses of the refined composite entity by automatically programming operations of training tools for use by the tennis player. This provides for tangible effects and benefits of the method for generating the composite entity.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

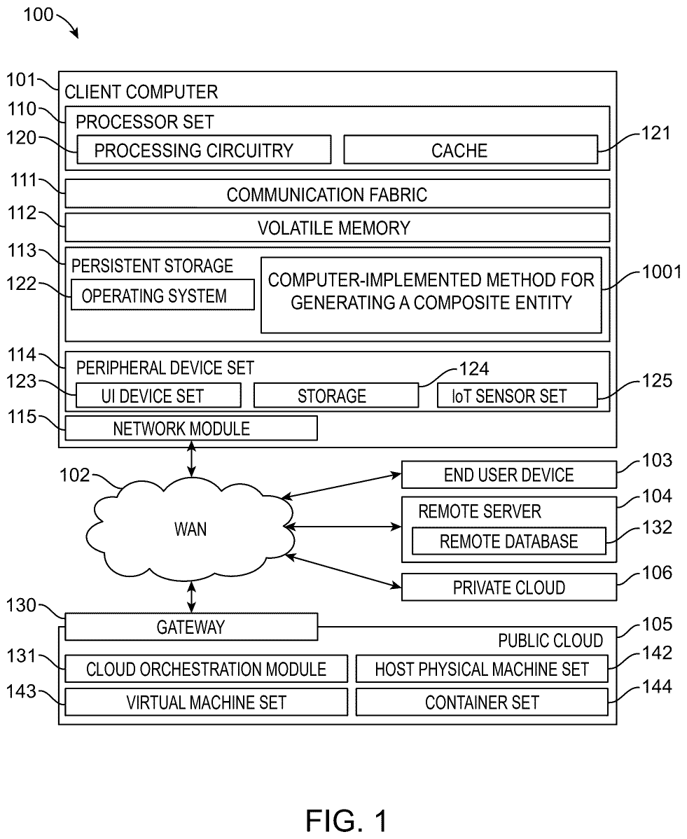

With reference to FIG. 1, a computer or computing device 100 that implements a computer-implemented method for generating a composite entity. The computer or computing device 100 of FIG. 1 contains an example of an environment for the execution of at least some of the computer code involved in performing the inventive methods, such as the block 1001 of the computer-implemented method for generating a composite entity. In addition to the computer-implemented method for generating a composite entity, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Turning now to an overview of technologies that are more specifically relevant to aspects of the invention, tennis is one of the most popular games around the globe and it has a huge fan-base. The fans are great supporters of their favorite player(s). Each player typically has one or more very well appreciated traits. For example, some players can serve very well and others are famous for their strong backhand. Similarly, each player also has some weakness.

Often the strength of one player proves heavier to the strong point of other player, or the weakness of a player becomes a root cause for losing a game. In either case, the participation of viewers and fans is usually limited to viewing and cheering for their favorite players while wondering why their favorite players lose or win possibly in spite of strength or weaknesses. In addition, tennis players may want to understand how skills and traits of other players could relate to winning or losing an upcoming game as well as how changes in traits could play a pivotal role in their performance over the time.

Turning now to an overview of the aspects of the invention, one or more embodiments of the invention address the above-described shortcomings of the prior art by providing for a method to discover strong tennis traits (attributes/skills) and build an amalgamation of selected skill sets and traits to a synthesized player. This synthesized player could thus represent the selected attributes from various players. Thus, fans can have their own synthesized players. This notion of synthesizing and agglomerating traits together can be used in many embodiments beyond tennis. For example, vehicles can be agglomerated together in both aesthetics and function from the real world into virtual spaces. The modeling and simulation environments can be used to test new products before construction. In addition, the method disclosed herein can be extended to e-gaming and video games where a real-world player or entity can be mixed with a plurality of fantasy players.

The methods disclosed herein give users a unique opportunity to create their own synthesized player entity, in the exemplary case of tennis, by selecting traits from different player entities. The player entities can be both virtual and physical or fractals thereof. Further, emergent player entities can be shared and deduced into other sharable forms. Novel causality measures separate aesthetics and function as much as variable independence enables. The synthesized entity can be simulated within an environment to assess the effectiveness of the agglomeration. Through simulation, a secondary entity will emerge that has agglomerated other aesthetics and function to self-improve. A third-degree entity will emerge based on forecasted trends of aesthetics and function. The triple store of entities represents a composite entity. Not only that, but the users can also use artificial intelligence (AI) tools to explore how their synthesized player will perform in tournaments like the US Open and to perform valuation ratings among such synthesized players.

The present disclosure provides for modeling and mixing performance of entities based on vortex modeling, causation measures of independence to separate the traits of aesthetics and function for agglomeration, a forecasted emergent entity based on aesthetic and function trends, a composite emergent entity based on self-improving secondary and forecasted third degree emergent entities, a sharing of any number of emergent entities within a composite entity for the creation of additional emergent entities, finely dissected representation of player's strength and weakness traits, finely detailed representation of various aspects of game for example, hardcourt or grass court, etc., user level environment definition based on user natural language processing of preference contents, layered selection of players traits (i.e., user can select different traits from different players), creation of a synthesized player by blending various layers traits selected from different players and discovery of vital traits that make a player to win or to loose.

Once the winning traits are identified, the present disclosure allows for creation of an adverse testing conditions that aim to identify any vulnerabilities in the game/environment which are being constantly exploited by the top traits. Causally identified data could be used to design virtual simulations that are more challenging, in turn making it possible to judge technique/skill more than raw talent. Using natural language processing (NLP), thousands of articles can be reviewed to determine what traits make a specific player strong and thus create a synthetic player from such traits. Using sound recognition and other AI methods, it can be determined when crowds best reacted to a player and boost those traits in the emerging player.

The present disclosure also provides for a method to determine a group of players that most closely resemble a synthetic player and to use combined vortex synergy to identify syncing skills that make multiple skills stronger together than they were individually.

The above-described aspects of the invention address the shortcomings of the prior art by providing a computer-implemented method for generating a composite entity. The computer-implemented method includes deriving a list of aesthetics and performance attributes for an entity, generating a directed acyclic graph (DAG) from the aesthetics and performance attributes, identifying prime aesthetics and prime performance attributes through independence testing of the DAG, defining logarithmic spiral expressions for each of the prime aesthetics and for each of the prime performance attributes, receiving a user input of selections of the prime aesthetics and the prime performance attributes and generating a composite entity from the selections of the prime aesthetics and the prime performance attributes through mixing of the logarithmic spiral expressions of the selections of the prime aesthetics and the prime performance attributes.

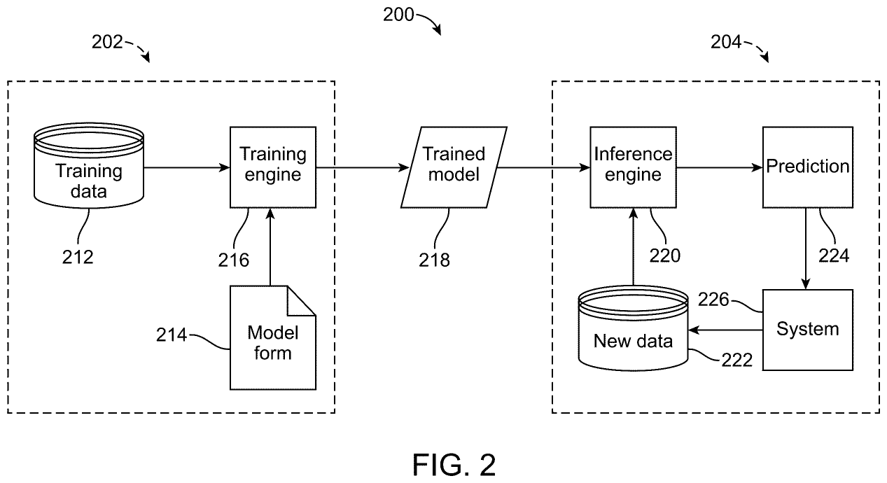

Turning now to a more detailed description of aspects of the present invention, FIG. 2 depicts a block diagram of components of a machine learning training and inference system 200. The machine learning training and inference system 200, in accordance with one or more embodiments of the invention, can utilize machine learning techniques to perform tasks, such as a computer-implemented method for generating a composite entity. Embodiments of the invention utilize AI, which includes a variety of so-called machine learning technologies. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for managing information during a web conference, for example. In one or more embodiments of the invention, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments of the invention described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of localizing a target object referred by a compositional expression from an image set with similar visual elements as described herein.

The machine learning training and inference system 200 performs training 202 and inference 204. During training 202, a training engine 216 trains a model (e.g., the trained model 218) to perform a task. Inference 204 is the process of implementing the trained model 218 to perform the task in the context of a larger system (e.g., a system 226).

The training 202 begins with training data 212, which can be structured or unstructured data. The training engine 216 receives the training data 212 and a model form 214. The model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 can be a model form of a CNN (convolutional neural network). The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 can be performed multiple times (referred to as “epochs”) until a suitable model is trained (e.g., the trained model 218).

Once trained, the trained model 218 can be used to perform inference 204 to perform a task. The inference engine 220 applies the trained model 218 to new data 222 (e.g., real-world, non-training data). For example, if the trained model 218 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226. The system 226 can, based on the prediction 224, taken an action, perform an operation, perform an analysis, and/or the like, including combinations and/or multiples thereof. In some embodiments of the invention, the system 226 can add to and/or modify the new data 222 based on the prediction 224.

In accordance with one or more embodiments of the invention, the predictions 224 generated by the inference engine 220 are periodically monitored and verified to ensure that the inference engine 220 is operating as expected. Based on the verification, additional training 202 can occur using the trained model 218 as the starting point. The additional training 202 can include all or a subset of the original training data 212 and/or new training data 212. In accordance with one or more embodiments of the invention, the training 202 includes updating the trained model 218 to account for changes in expected input data.

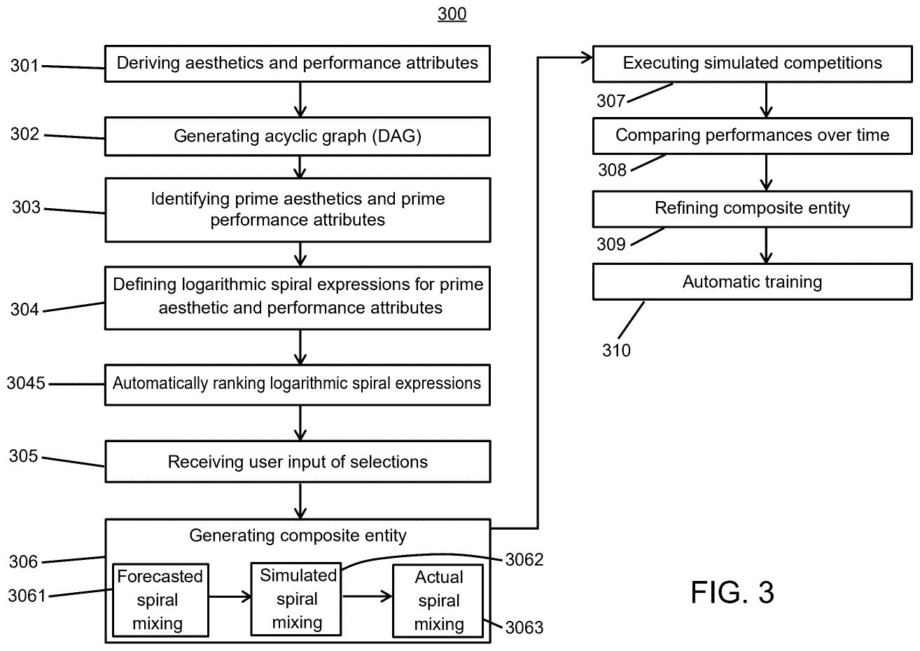

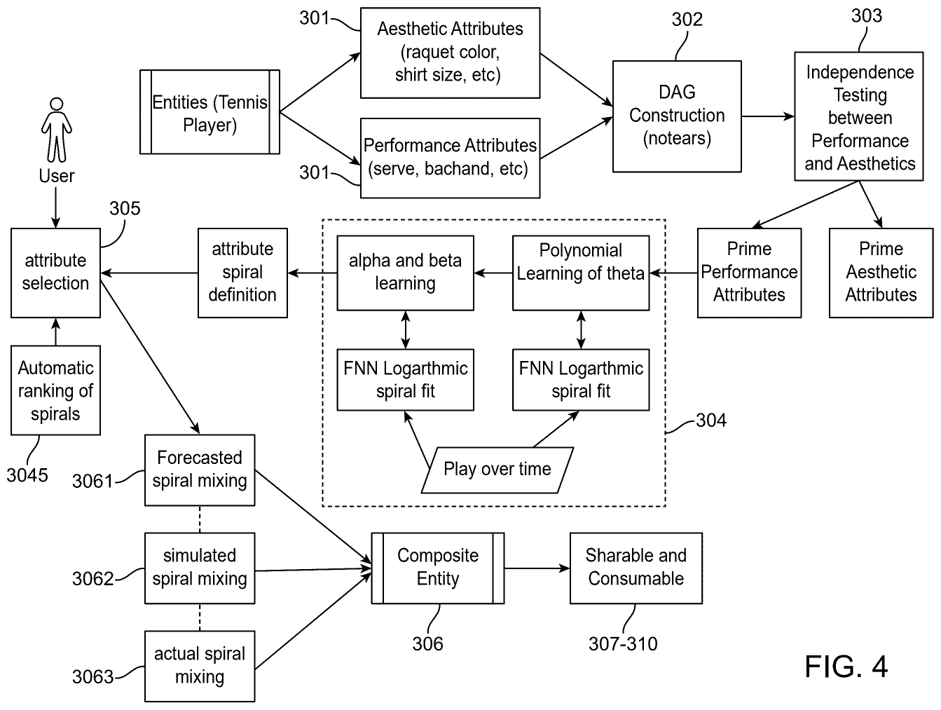

With reference to FIGS. 3 and 4, a computer-implemented method 300 is provided for generating a composite entity. As shown in FIGS. 3 and 4, the computer-implemented method 300 includes deriving a list of aesthetics and performance attributes for an entity (block 301). In accordance with one or more embodiments, the entity can be a tennis player and the aesthetics can include things like racquet colors and tennis clothes of the entity and the performance attributes can include tennis skills of the entity. It is to be understood, however, that the description provided herein is applicable to all types of entities and that the reference to tennis is merely exemplary. The following description will continue to refer to tennis for purposes of clarity and brevity.

The computer-implemented method 300 also includes generating a directed acyclic graph (DAG) from the aesthetics and the performance attributes (block 302) and identifying prime aesthetics and prime performance attributes through independence testing of the DAG (block 303). The generating of the DAG from the aesthetics and performance attributes of block 302 can be accomplished by stratifying the aesthetics and the performance attributes whereby a dimensionally reduced description of the entity is combinable with the DAG. The identifying of the prime aesthetics and the prime performance attributes through the independence testing of the DAG of block 303 can be accomplished by determining whether any of the aesthetics and the performance attributes in the list are independent from causal testing. The determining can include, for example, a single aesthetic feature being combined with all performance features and altered to determine if a belief network updates. In addition, different belief network evidence is bound searched and locked in to see if the aesthetic attribute is changed. If the belief network does not effect a change (i.e., an overall assessment of wins or losses when range testing) or does not effect a change in neighboring nodes, it can be accepted that the aesthetic attribute is independent from causal testing.

The computer-implemented method 300 further includes defining logarithmic spiral expressions for each of the prime aesthetics and for each of the prime performance attributes (block 304), automatically ranking the logarithmic spiral expressions for each of the prime aesthetics and for each of the prime performance attributes (block 3045), receiving a user input of selections of the prime aesthetics and the prime performance attributes (block 305) and generating a composite entity from the selections of the prime aesthetics and the prime performance attributes through mixing of the logarithmic spiral expressions of the selections of the prime aesthetics and the prime performance attributes (block 306). The mixing of the logarithmic spiral expressions of the selections of the prime aesthetics and the prime performance attributes of block 306 can include forecasted spiral mixing (block 3061), simulated spiral mixing (block 3062) and actual spiral mixing (block 3063).

The defining of the logarithmic spiral expressions for each of the prime aesthetics and for each of the prime performance attributes of block 304 can include observing each of the prime aesthetics and each of the prime performance attributes over time and using feed forward networks (FFNs) to execute logarithmic spiral fits toward learning θ, α and β components of each of the logarithmic spiral expressions for each of the prime aesthetics and each of the prime performance attributes.

As used herein, an equation of a logarithmic spiral is: r=αe^{β} θ, where r is a distance of a point from a central origin, θ is an angle from an x-axis, α changes a radius scale and β change a phase shift. In parametric form, the equation derives to:

x=α cos θe^{βθ},

y=α sin θe^{βθ}, and

x(θ)+iy(θ)=α cos θe^{δθ}+i(α sin θe^{βθ}).

For a given attribute, the player (i.e., the entity) will have a highest potential energy at the origin with energy being transferred to the environment during action or tennis play and the logarithmic spiral begins for the attribute over play such that a conversion from time to phi is learned for each player such that a polynomial equation is defined:

f(t)=θ.

Now, the FFNs learn time related to θ and phase and scale shifting of the player. The time component describes how the attribute uses the energy of the player thereby moving the spiral away from the origin. The phase and scale shifting of the player. The phase shift of the player is relative to him/herself while the scale shifting (α) is relative to other players.

The FFNs are fit with objectives to produce a spiral relationship with additional labels, such as if the player wins or loses. The spiral relationship is tested with a series of times to determine if it produces a spiral signature. The neural network topology is fixed with activation functions that can learn weights over time. This produces an α, a β and a phi that correspond to the spirals.

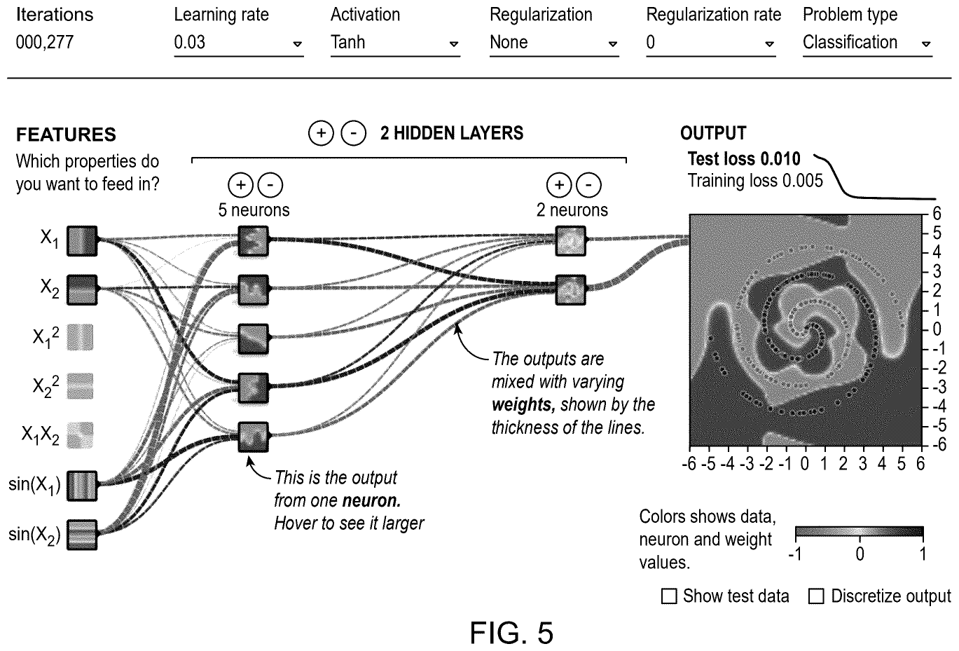

With reference to FIG. 5, each aesthetic and performance attribute can have a spiral signature. The tighter the spiral the more energy is conserved and the larger the spiral the more energy that is transferred to the environment. Convolutional neural networks (CNNs) can then be used to analyze the spirals to rank the attributes from strengths to weaknesses, to identify the spirals and then to quantify CNN-recognized spirals using the logarithmic spiral equations to rank traits. A machine language (ML) model random forest can be used to take the spiral information and player data to rank the importance of a given trait (e.g., an ability to come to the net and play volley shots is expected to be better for an experienced player rather than some newer player).

Each of the attribute spirals from the real world are then recreated using forecasted and simulated play data. This information then produces potentially different spirals that then makeup the composite entity. Each of the spirals can be socially shared or used by another algorithm.

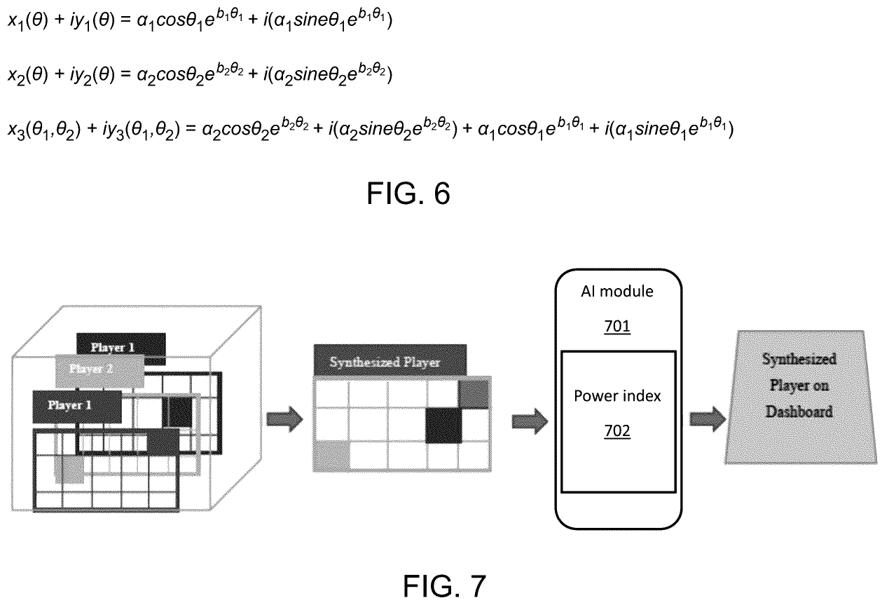

With reference to FIG. 6, the spirals can be mixed across entities or players based on the attribute name. This allows for spirals to be defined for a new entity.

With reference to FIG. 7, which illustrated an overall flow of the computer-implemented method 300 of FIG. 3, a user will have a list of players and various attributes (strengths, weaknesses, etc.) for each player. The user can then select the desired traits from the players and thus can create a synthesized player. The synthesized player will have various traits from different players and can be supplied to an AI module 701 that can analyze various features of this player and, based on these attributes, can generate a power index 702 for the synthesized player. Based on a current performance of a parent player from whom the trait is inherited, a performance of the synthesized player will also change, and hence the power index 702 of the synthesized player will also change.

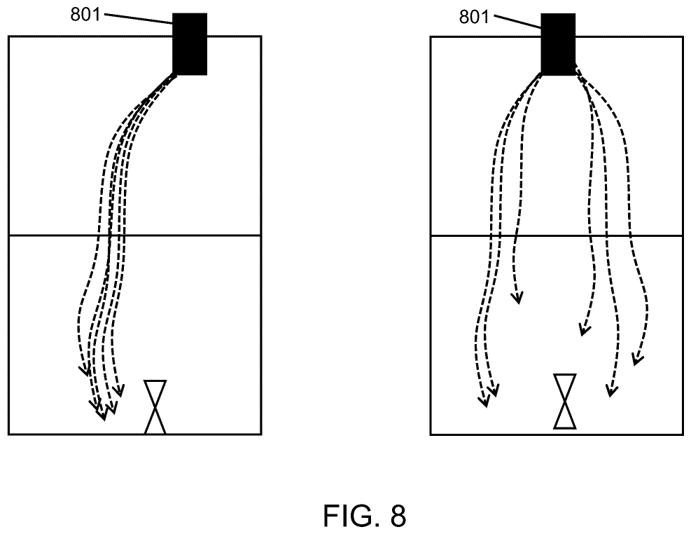

With reference back to FIGS. 3 and 4 and with additional reference to FIG. 8 and in accordance with one or more embodiments, with the entity being a tennis player and the composite entity being a virtual tennis player, the computer-implemented method 300 further includes executing multiple simulated competitions between the virtual tennis player and other virtual tennis players (block 307), comparing performances over time of the virtual tennis player in the simulated competitions with performances over time of the tennis player in actual competitions (block 308), refining the composite entity based on results of the comparing to generate a refined composite entity (block 309) and automatically training the tennis player to improve based on exhibited weaknesses of the refined composite entity by automatically programming operations of training tools for use by the tennis player (block 310).

As shown in FIG. 8, the automatic training of the tennis player to improve based on exhibited weaknesses of the refined composite entity by automatically programming operations of training tools for use by the tennis player can be accomplished by, for example, programming a ball dispenser 801 to dispense tennis balls in a particular manner. That is, in a case the player's backhand has been demonstrated to be an exhibited weakness of the player over time, the ball dispenser 801 can be programmed to dispense tennis balls toward the player's backhand an increased numbers of times during training sessions as illustrated in the left-image of FIG. 8. In another case where the player's fitness has been demonstrated to be an exhibited weakness of the player over time, the ball dispenser 801 can be programmed to dispense tennis balls toward a greater variety of locations on a tennis court during training sessions in order to force the player to run more during those training sessions as illustrated in the right-image of FIG. 8.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for generating a composite entity, the computer-implemented method comprising:
deriving a list of aesthetics and performance attributes for an entity;
generating a directed acyclic graph (DAG) from the aesthetics and the performance attributes;
identifying prime aesthetics and prime performance attributes through independence testing of the DAG;
defining logarithmic spiral expressions for each of the prime aesthetics and for each of the prime performance attributes;
receiving a user input of selections of the prime aesthetics and the prime performance attributes; and
generating a composite entity from the selections of the prime aesthetics and the prime performance attributes through mixing of the logarithmic spiral expressions of the selections of the prime aesthetics and the prime performance attributes.

2. The computer-implemented method according to claim 1, wherein:
the entity is a tennis player,
the aesthetics comprise racquet colors and tennis clothes of the entity, and
the performance attributes comprise tennis skills of the entity.

3. The computer-implemented method according to claim 1, wherein the identifying of the prime aesthetics and the prime performance attributes comprises determining whether any of the aesthetics and the performance attributes in the list are independent from causal testing.

4. The computer-implemented method according to claim 1, wherein the defining of the logarithmic spiral expressions for each of the prime aesthetics and for each of the prime performance attributes comprises:
observing each of the prime aesthetics and each of the prime performance attributes over time; and
using feed forward networks (FFNs) to execute logarithmic spiral fits toward learning Θ, α and β components of each of the logarithmic spiral expressions for each of the prime aesthetics and each of the prime performance attributes.

5. The computer-implemented method according to claim 1, further comprising automatically ranking the logarithmic spiral expressions for each of the prime aesthetics and for each of the prime performance attributes.

6. The computer-implemented method according to claim 1, wherein the mixing of the logarithmic spiral expressions of the selections of the prime aesthetics and the prime performance attributes comprises forecasted spiral mixing, simulated spiral mixing and actual spiral mixing.

7. The computer-implemented method according to claim 1, wherein the entity is a tennis player and the composite entity is a virtual tennis player and the computer-implemented method further comprises:
executing multiple simulated competitions between the virtual tennis player and other virtual tennis players;
comparing performances over time of the virtual tennis player in the simulated competitions with performances over time of the tennis player in actual competitions;
refining the composite entity based on results of the comparing to generate a refined composite entity; and
automatically training the tennis player to improve based on exhibited weaknesses of the refined composite entity by automatically programming operations of training tools for use by the tennis player.

8. A computer program product for generating a composite entity, the computer program product comprising one or more computer readable storage media having computer readable program code collectively stored on the one or more computer readable storage media, the computer readable program code being executed by a processor of a computer system to cause the computer system to perform a method comprising:
deriving a list of aesthetics and performance attributes for an entity;
generating a directed acyclic graph (DAG) from the aesthetics and the performance attributes;
identifying prime aesthetics and prime performance attributes through independence testing of the DAG;
defining logarithmic spiral expressions for each of the prime aesthetics and for each of the prime performance attributes;
receiving a user input of selections of the prime aesthetics and the prime performance attributes; and
generating a composite entity from the selections of the prime aesthetics and the prime performance attributes through mixing of the logarithmic spiral expressions of the selections of the prime aesthetics and the prime performance attributes.

9. The computer program product according to claim 8, wherein:
the entity is a tennis player,
the aesthetics comprise racquet colors and tennis clothes of the entity, and
the performance attributes comprise tennis skills of the entity.

10. The computer program product according to claim 8, wherein the identifying of the prime aesthetics and the prime performance attributes comprises determining whether any of the aesthetics and the performance attributes in the list are independent from causal testing.

11. The computer program product according to claim 8, wherein the defining of the logarithmic spiral expressions for each of the prime aesthetics and for each of the prime performance attributes comprises:
observing each of the prime aesthetics and each of the prime performance attributes over time; and
using feed forward networks (FFNs) to execute logarithmic spiral fits toward learning Θ, α and β components of each of the logarithmic spiral expressions for each of the prime aesthetics and each of the prime performance attributes.

12. The computer program product according to claim 8, wherein the method further comprises automatically ranking the logarithmic spiral expressions for each of the prime aesthetics and for each of the prime performance attributes.

13. The computer program product according to claim 8, wherein the mixing of the logarithmic spiral expressions of the selections of the prime aesthetics and the prime performance attributes comprises forecasted spiral mixing, simulated spiral mixing and actual spiral mixing.

14. The computer program product according to claim 8, wherein the entity is a tennis player and the composite entity is a virtual tennis player and the method further comprises:
executing multiple simulated competitions between the virtual tennis player and other virtual tennis players;
comparing performances over time of the virtual tennis player in the simulated competitions with performances over time of the tennis player in actual competitions;
refining the composite entity based on results of the comparing to generate a refined composite entity; and
automatically training the tennis player to improve based on exhibited weaknesses of the refined composite entity by automatically programming operations of training tools for use by the tennis player.

15. A computing system comprising:
a processor;
a memory coupled to the processor; and
one or more computer readable storage media coupled to the processor, the one or more computer readable storage media collectively containing instructions that are executed by the processor via the memory to implement a method for generating a composite entity comprising:
deriving a list of aesthetics and performance attributes for an entity;
generating a directed acyclic graph (DAG) from the aesthetics and the performance attributes;
identifying prime aesthetics and prime performance attributes through independence testing of the DAG;
defining logarithmic spiral expressions for each of the prime aesthetics and for each of the prime performance attributes;
receiving a user input of selections of the prime aesthetics and the prime performance attributes; and
generating a composite entity from the selections of the prime aesthetics and the prime performance attributes through mixing of the logarithmic spiral expressions of the selections of the prime aesthetics and the prime performance attributes.

16. The computing system according to claim 15, wherein:
the entity is a tennis player,
the aesthetics comprise racquet colors and tennis clothes of the entity, and
the performance attributes comprise tennis skills of the entity.

17. The computing system according to claim 15, wherein the identifying of the prime aesthetics and the prime performance attributes comprises determining whether any of the aesthetics and the performance attributes in the list are independent from causal testing.

18. The computing system according to claim 15, wherein the defining of the logarithmic spiral expressions for each of the prime aesthetics and for each of the prime performance attributes comprises:
observing each of the prime aesthetics and each of the prime performance attributes over time; and
using feed forward networks (FFNs) to execute logarithmic spiral fits toward learning Θ, α and β components of each of the logarithmic spiral expressions for each of the prime aesthetics and each of the prime performance attributes.

19. The computing system according to claim 15, wherein the mixing of the logarithmic spiral expressions of the selections of the prime aesthetics and the prime performance attributes comprises forecasted spiral mixing, simulated spiral mixing and actual spiral mixing.

20. The computing system according to claim 15, wherein the entity is a tennis player and the composite entity is a virtual tennis player and the method further comprises:
executing multiple simulated competitions between the virtual tennis player and other virtual tennis players;
comparing performances over time of the virtual tennis player in the simulated competitions with performances over time of the tennis player in actual competitions;
refining the composite entity based on results of the comparing to generate a refined composite entity; and
automatically training the tennis player to improve based on exhibited weaknesses of the refined composite entity by automatically programming operations of training tools for use by the tennis player.
